(19) United States
(12) Patent Application Publication
(10) Pub. No.: US 2019/0171684 A1
(43) Pub. Date: Jun. 6, 2019

(54) PERSONAL USER FOCUSED INTELLIGENT RESPONSIVE SEARCH SYSTEM

(71) Applicant: Shocase, Inc., San Francisco, CA (US)

(72) Inventors: Ronald P. Young, Mill Valley, CA (US); David Anthony Burgess, Menlo Park, CA (US); Jonathan Trevor, Menlo Park, CA (US); Peter Rugg, New York, NY (US)

(73) Assignee: Shocase, Inc., San Francisco, CA (US)

(21) Appl. No.: 16/271,764

(22) Filed: Feb. 8, 2019

Related U.S. Application Data
(63) Continuation of application No. 15/045,554, filed on Feb. 17, 2016, now abandoned.
(60) Provisional application No. 62/116,946, filed on Feb. 17, 2015.

(51) Int. Cl. G06F 16/9535; G06F 16/33

(52) U.S. Cl. CPC G06F 16/9535; G06F 16/3338

(57) ABSTRACT

A method of presenting a set of search results includes the steps of: receiving a query input by a user, the query comprising one or more search terms; generating the set of search results; filtering the generated set of search results; ranking the filtered set of search results; displaying the ranked set of search results. At least one of the generating, filtering, ranking, and displaying are based on the one or more search terms and are further based on at least one additional stored item. The additional stored item is related to the user and/or the query. The additional stored item includes at least one of: an ontology of the one or more search terms, a personal profile of the user, and a search history of the user.

### CROSS-REFERENCE TO RELATED APPLICATIONS

This patent application claims the benefit of U.S. Provisional Patent Application Ser. No. 62/116,946 filed on Feb. 17, 2015, entitled “Personal User Focused Intelligent Responsive Search System,” the complete disclosure of which is expressly incorporated herein by reference in its entirety for all purposes.

### FIELD

The present invention applies to computer software, particularly Internet software that facilitates networking and search applications.

### BACKGROUND

In computer and database systems, an efficient method of searching the data is very important. Any user searching for information will find a search engine more responsive if the search is not only complete, but also presented in a sequence that has a high probability of delivering the desired information as directly and rapidly as possible. Oftentimes, search algorithms under the control of the search engine are subject to various conditions imposed upon them to satisfy advertisers or simply to present as many results as possible in an additive process. This can be overwhelming when trying to home in on a particular search query, especially when used in the context of a social network.

The general concept of methods for searching on a computer system are known, be it in a database or the Internet, and for presenting search results. Ordering search results may include a Bayesian posterior probability for relevancy between the search results and the search request in response to receiving a search request submitted by a user, finding expected values of relevancy between the submitted search request and data that is relevant to the submitted search request from the search data structure, and ordering the found data in a descending order of the expected value.

It is also known, in the general sense, to prioritize results based purely on popular searches and popular URLs (Uniform Resource Locators). Basic search results are often ordered based on relevancy to the query versus data. The search may even return results as the user types and before a full search is entered. Due to the sometimes very large numbers of retrieved search results, there exists a demonstrated history of the benefits of filtering and/or ordering search results that benefit a user's search.

### SUMMARY

In one aspect, a method of presenting a set of search results includes the steps of: receiving a query input by a user, the query comprising one or more search terms; generating the set of search results; filtering the generated set of search results; ranking the filtered set of search results; and displaying the ranked set of search results. At least one of the steps of generating, filtering, ranking, and displaying are based on the one or more search terms and are further based on at least one additional stored item. The additional stored item is related to at least one of the user or the query. The additional stored item includes at least one of: an ontology of the one or more search terms, a personal profile of the user, and a search history of the user.

In another aspect, a system for presenting a set of search results includes: means for receiving a query input by a user, the query input comprising one or more search terms; means for generating the set of search results; means for filtering the generated set of search results; means for ranking the filtered set of search results; and means for displaying the ranked set of search results. At least one of the means for generating, filtering, ranking, and displaying are further based on at least one additional stored item. The additional stored item is related to at least one of the user or the query. The additional stored item includes at least one of: an ontology of the one or more search terms, a personal profile of the user, and a search history of the user.

As used herein, “facilitating” an action includes performing the action, making the action easier, helping to carry the action out, or causing the action to be performed. Thus, by way of example only and without limitation, in the context of a processor-implemented method, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIGS. 1A and 1B show at least a portion of an exemplary flow chart comparing traditional search engines and search engines which access extended information to further hone the displayed results of interest to the user;

FIG. 2 conceptually depicts an illustrative layout of a search on a computer screen including search query field and results list;

FIGS. 3A and 3B conceptually depict an exemplary initial search for both a basic search engine and a personal-focused search engine, which considers a multitude of factors with an aim to increasing the relevancy of its results ordering, according to an embodiment of the invention;

FIGS. 4A and 4B conceptually depict an exemplary secondary search for both a basic search engine and a personal-focused search engine, that considers a multitude of factors with an aim to increasing the relevancy of its results ordering, according to an embodiment of the invention; and

FIGS. 5A and 5B conceptually depict an exemplary tertiary search for both a basic search engine and a personal-focused search engine, which considers a multitude of factors with an aim to increasing the relevancy of its results ordering, according to an embodiment of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of the present disclosure will be described herein in the context of illustrative methods and apparatus which facilitate social networking applications. It is to be appreciated, however, that the specific embodiments and/or methods illustratively shown and described herein are to be considered exemplary rather than limiting. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Some embodiments of the present invention may include Internet software that facilitates networking applications, such as applications associated with social networks. Social networks are systems that permit users to become members and as members to utilize the system to socialize with other member users, and may include a system for social networking and/or social collaborating. This system may be an Internet site, website, application, software or more, and might be on a computer, smart phone, tablet or other user device and may be published in whole or in part or in summary in the system.

Embodiments of the present invention are directed at offering a user with the best arranged in terms of presentation and hence most efficient list of relevant results by using intelligent filtering and ordering. An illustrative embodiment of the invention includes a unique search system that considers a number of factors beyond the search string itself which could influence user interest level. The search results are presented to the user in the most useful order.

A search, in one or more embodiments, may be a search for a person, a project, a company or an organization, among other criteria. Embodiments of the instant system employ a search engine that looks not only at the original search query, but also at other pertinent information, including, for example, ontology of the search terms, the user's own profile, recent search history and other information, stored or otherwise. Here, the term “ontology” is broadly defined as a set of concepts and/or categories in a given subject area or domain that shows their properties and the relations between them. It is these additional elements that enable a more intelligently presented results list which is prioritized more toward what the user is expected to be looking for. Additional search results are brought into the search with an ontology algorithm, and the order of the presentation of results is focused at the top portion of the listed results with user profile and previous search.

Illustrative embodiments may also determine one or more entities within the query, each entity comprising one or more search terms, and use ontologies associated with those entities in addition to (or instead of) ontologies associated with individual search terms and/or ontologies associated with the query as a whole. For example, the query “Coke Ad San Francisco” may include entities “Coke,” “Coke Ad,” and “San Francisco.” One can then categorize these entities: Coke is a brand or company, Coke Ad is an advert, San Francisco is a location. One can then look at the ontology for each category. Coke as a brand has synonyms, i.e. is also called Coca-Cola, and is a soft drink, with other soft drinks by this brand including Diet Coke and Coke Zero, while competing soft drinks include Pepsi and Sprite. San Francisco is a city in California's Bay Area and other nearby cities include Oakland, Berkeley, Palo Alto, and San Jose. One can use the entities, their categories and the ‘closeness’/′relatedness' of other entities in the ontology to expand the search criteria and improve the relevance of the search results.

One or more exemplary embodiments may utilize a user's behavioral history, including search history, as follows: a weighting is assigned to each event (which may include one or more of a search query, a click, and a page view). Each event is categorized with the weights depending on the event type: for example, a search query may have a larger weight than a click, which may have a larger weight than a page view. A given weight may also decrease in strength (according to a formula) with an increase in the elapsed period of time since the associated event.

Illustrative embodiments of the present invention include a system and method of ordering and presenting search results from a user-input search string that uses not only that search string, but one or more other user-related factors, including, but not limited to, topic-specific language ontology, characteristics of the user's person, demographics, behavior, profession and location, and recent historic search criteria to determine the filtering and ordering of the results. Embodiments of the present invention advantageously take into account the broader nature of what data is used to intelligently order search results. Thus, an illustrative embodiment may include a system and/or method that enhances search filtering, results ranking and presentation based primarily on specified search term elements; secondly, on ontology to predict a specific meaning of certain words in a given industry or location; thirdly, on certain user profile attributes such as, for example, profession, age, gender, location or language; and fourthly, on recent search queries or other behavioral history.

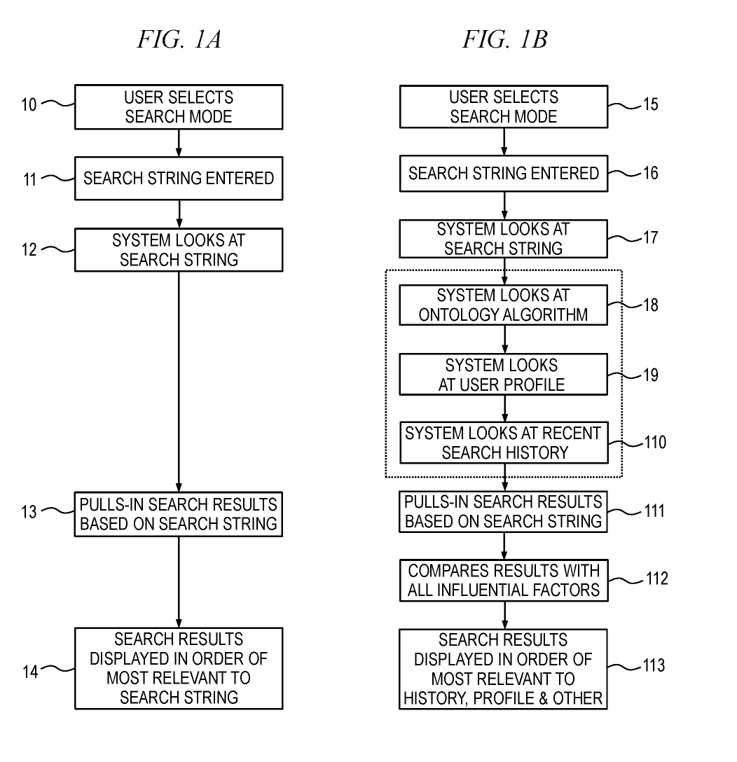

FIGS. 1A and 1B depict respective flow charts detailing the operation of two different illustrative search engines. FIG. 1A depicts how a basic search engine reacts to a user-input search string. Initially, the user selects the search mode 10 and enters their search string 11 into the query box. The search engine looks solely at the search string for key words and compares it to an index or log file of information on the system 12. Search results that exactly or closely match the elements in the search query are pulled-in 13 and finally the results are displayed to the user in order of most relevant to the search query 14. The ordering of these results can vary but generally show exact matches to all user query elements at the top of the list and less relevant matches to one or more, but not all the search elements, further down. Additionally, other factors come into play, such as advertising requirements imposed upon a search engine. The search engine can apply its own system of weighting to the results which can skew the results list to something less relevant to the user.

FIG. 1B depicts an illustrative method of data flow in a more intelligent search engine system. Once again, a user selects search mode 15 and enters a search query 16. The engine looks at that search query 17, but this time also considers other factors, which may help to weigh the results in a more useful manner to the user. One or more elements are considered depending on what is available to the search engine, including, but not limited to, system ontology 18, a profile of the user conducting the search 19, and recent searches (i.e., search history) conducted by the user 110. The search results that match the original search query are pulled-in 111, and this time the results are compared 112 with the additional factors 18, 19 and 110 and given a weighting depending on considered relevance. When the search is in a system related to film or video, terms such as “cut,” “cam,” “set,” and “take” may be tuned by the algorithm in 18 to prescribed special meanings relative to video, in one or more embodiments. In an advertising related system, the algorithms in 18 might interpret the terms “spot,” “commercial” and “sponsor” from their general meanings to different meanings attributable in the context of an advertising environment. The ontology algorithms in 18 could be based on the query (e.g., based on one or more entities within the query as discussed above) and additionally and/or alternatively could be based at least in part on the user.

In one or more embodiments, search results are displayed in an order based on their relevance weighting, with most relevant at the top of the list and less relevant further down 113. The relevance weighting in the system is increased for search results showing greater relevance to the user's personal or recent search history. By way of example only and without limitation, a user who is a cowboy may have greater relevance assigned to search results bearing the terms horse or ranch. Likewise, a recent search history on marine mammals will increase the relevance of search results about zoos when seals or penguins are in the search result. By shifting the relevance of results based on these other factors, a searching user is preferably presented with high level results that have a greater probability of meeting his or her specific search objectives.

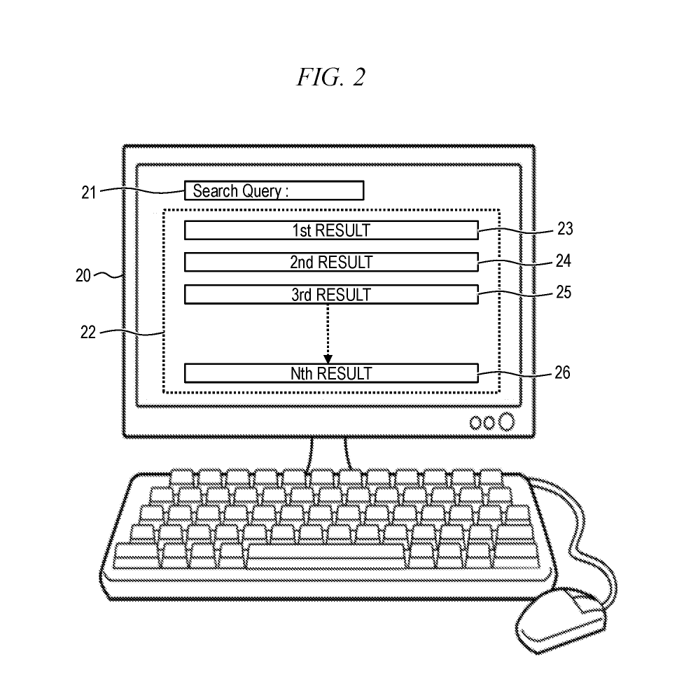

FIG. 2 shows a computer displaying an illustrative query and a corresponding results presentation 20. With reference to FIG. 2, at the top of the screen is a search query bar 21 where a user enters a search string of key words, which can be, for example, for people, projects, companies or more. Results of the search are shown below this 22 in order of most relevant at the top 23, 24 and 25, continuing to lesser relevant results at the bottom of the list 26.

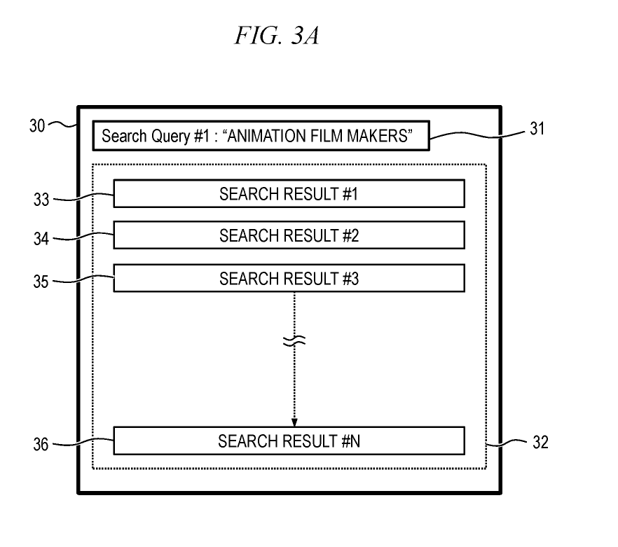

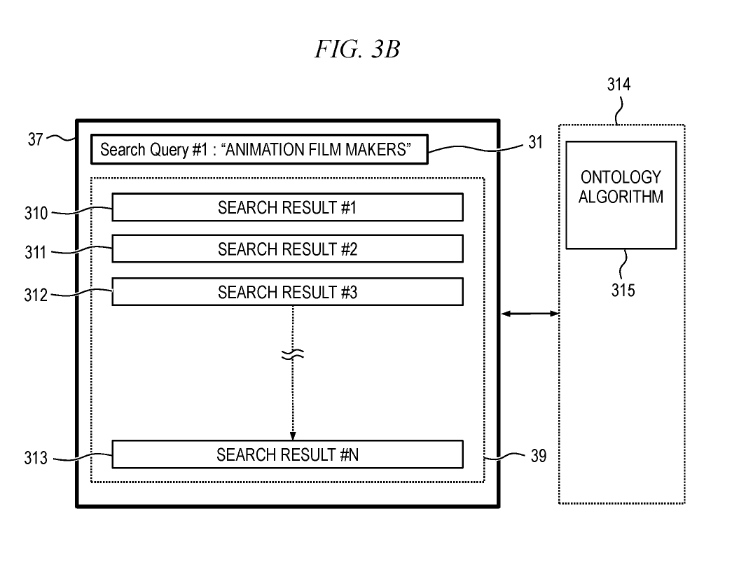

FIGS. 3A and 3B conceptually depict an exemplary initial search query for “Animation Film Makers,” according to an embodiment of the invention. FIG. 3A shows how results are selected and presented for a basic search engine 30. The user initially adds his or her search term into a search box 31. A list of corresponding results 32 is then presented to the user below this. In the case of this basic search engine, a simple ordering of results is presented based at least in part on the search string itself. The first few search results 33, 34, 35 might be those conforming exactly to the search query. For instance, the first result 33 might be a company that specializes in film animation production. The second result 34 might be a company that makes animated film tools. The third result 35 might be an advertisement for an animated film. The later result 36 would be far less relevant to the user and might ignore the animation keyword completely and just be for a filmmaker. As can be seen, in one or more embodiment, results ordering is based solely on the original search query 31 and relevance weighting is assigned purely on that string of key words and partially on advertising requirements imposed on the search engine.

FIG. 3B shows the same initial search for an intelligent user-focused search engine 37, according to an embodiment of the invention. The same search string 31 is entered into the search box. A list of corresponding search results 39 is presented to the user below this. In the case of the instant search engine method, other factors are now considered 314. The search system has evaluated the ontology to consider film animation of images rather than basic animation such as a lamb gamboling in a field. Therefore, a first search result 310 in the focused search embodiment of FIG. 3B will be different from the first result 33 in FIG. 3A, and might be, for example, a company that has made only animated films. The second result 311 might, as a matter of chance, be the same as in a non-focused search system. The third result 312 might be for a person who creates training animation use in schools. Result 312 may have been far lower on the results in FIG. 3A, because of the several plastic sheet suppliers may be filmmakers in a non-relevant or less-relevant context. As with the basic search engine in FIG. 3A, the later result 313 would be far less relevant to the user and might ignore the animation keyword completely and just be for a filmmaker of documentaries. As can be seen, the results ordering is based on more than just the search query. In this case, the system ontology algorithm is considered and the weighting of the results leans more towards the context of the three search elements together rather than individually.

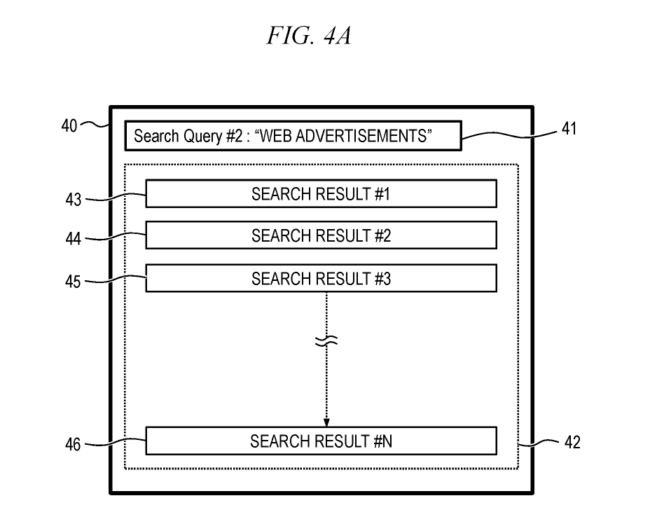

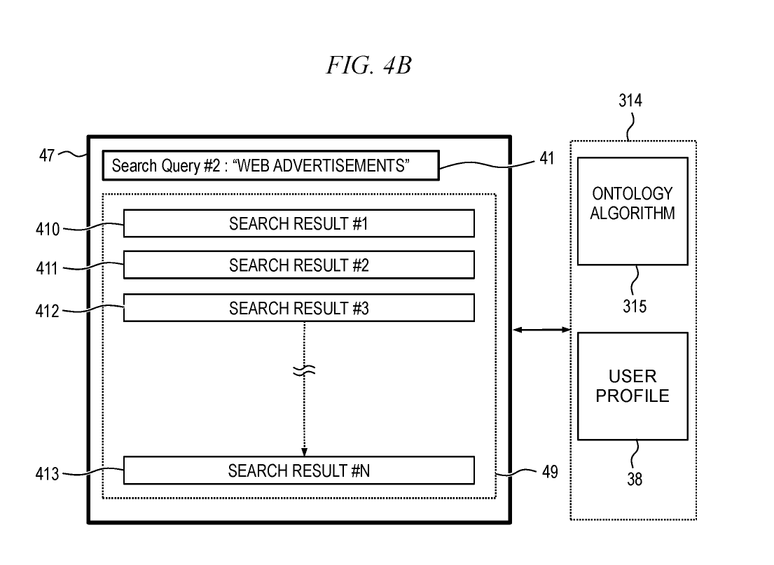

FIGS. 4A and 4B depict a secondary illustrative search query for “Web Advertisements,” according to an embodiment of the invention. FIG. 4A shows how illustrative results are selected and presented for a basic (non-focused) search engine 40. A search string is entered into a search box 41. A list of corresponding search results 42 is presented to the user below this. Once again, because the basic search engine only considers the search query as its sole source for pulling in a list of results, the first few results 43, 44, 45 might be for companies that have placed ads on web pages for climbers web harnesses or duck foot dishes in a Chinese restaurant, with the later result 46 being the least relevant to the user and might ignore the “web” keyword and instead list companies that show roadside billboard advertisements or place advertisements in printed media.

FIG. 4B shows the secondary search using the instant method for the intelligent user-focused search system 47. The search string 41 is the same as entered into the search box in FIG. 4a. The list of results 49 is presented to the user. The instant system for a user-focused search engine now considers other factors 314 including both the system ontology algorithm 315 and the user profile 38 are taken into account in conjunction with the initial search query 41. The ontology algorithm would link the words web and advertisements to increase the relevance of digital ads on the Internet. If the user profile 38 showed the user to be car salesman, the list of search results 49 might now start with web (or other Internet) adverts for car manufacturers at the top of the list 410. This might be followed by equally focused results for web adverts for other vehicles 411 and automotive web adverts 412 moving through progressively less relevant results to the final result 413.

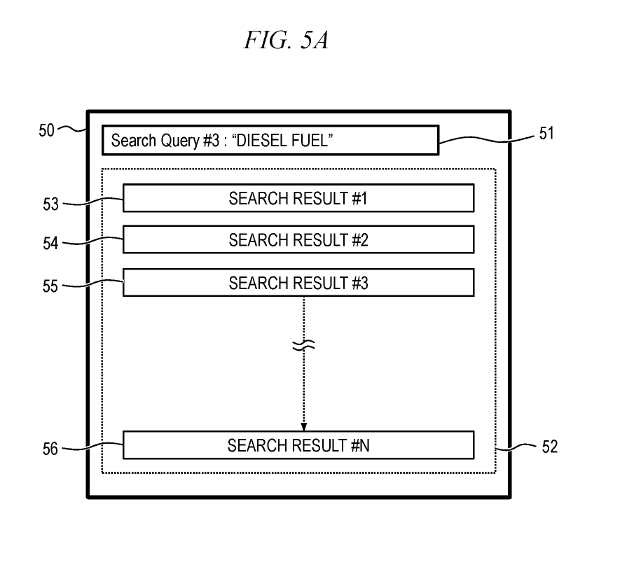

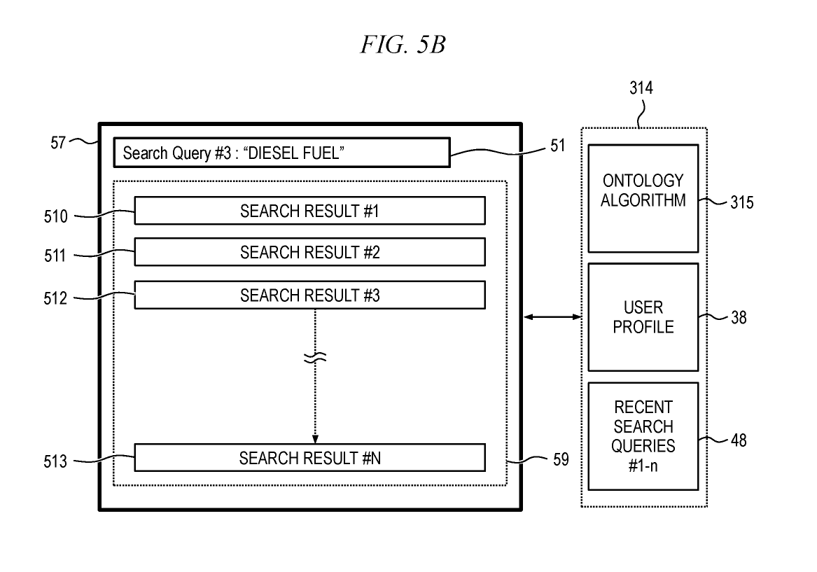

FIG. 5A further considers a third search query for “Diesel Fuel.” Specifically, FIG. 5A conceptually depicts how results are selected and presented for a basic search engine 50, according to an embodiment of the invention. The search string 51 is entered into the search box. The search results are ordered relevant only to the search string and in isolation of any other factors. The list of results 52 is presented to the user below this. In the case of this basic search engine, the first few search results 53, 54, 55 would be based around anything matching the key words in the search field, such as motors running on diesel fuel, prices for diesel fuel, and diesel fuel regulations, with the later result 56 being far less relevant to the user and might just focus on one of the search words such a peat for a fuel.

FIG. 5B shows the same third search query utilizing an exemplary system for intelligent user-focused search 57, according to an embodiment of the invention. With reference to FIG. 5B, a search string 51 is entered into the search box. A list of corresponding results 59 is presented to a user below this. This time, the instant method for focused personal search has even more system elements 314 to utilize when presenting its results 59. In addition to the system ontology 315 and user-profile 38, the system accesses recent search query key-words 48 (i.e., historical search data). In this exemplary embodiment, a top search result 510 might be for an animated web-based film advert for a diesel car followed by a television short on the creative director of an advertisement for a diesel car 511 and an animated presentation of the diesel fuel industry 511. The final result 513 might be less useful to the user, such as a picture of diesel engine parts.

In summary, embodiments of the method and system for personalized search focus intelligently utilize available information more efficiently to better match the interests and objectives of the user. Should the user wish to change his or her focus following a call from his or her spouse about a date night, for example, he or she can either clear the search history, or enter a new search string for romantic movies and restaurants.

In a first aspect, a method of presenting a set of search results includes the steps of: receiving a query input by a user, the query comprising one or more search terms; generating the set of search results; filtering the generated set of search results; ranking the filtered set of search results; and displaying the ranked set of search results. At least one of the steps of generating, filtering, ranking, and displaying are based on the one or more search terms and are further based on at least one additional stored item. The additional stored item is related to at least one of the user or the query. The additional stored item includes at least one of: an ontology of the one or more search terms, a personal profile of the user, and a search history of the user. In one or more exemplary embodiments, at least one of the generating, filtering, ranking, and displaying are based on the one or more search terms, the ontology of the one or more search terms, the personal profile of the user, and the search history of the user.

In some embodiments, the at least one additional stored item is related to the query and comprises an ontology of the one or more search terms. The ontology may comprise a topic specific language ontology. By way of example, the ontology may comprise an algorithm to determine a meaning of at least one of the one or more search terms in a specific industry or location. Additionally and/or alternatively, the ontology may comprise an algorithm to determine a meaning of at least one of the one or more search terms with reference to a specific brand, company, project or organization. Additionally and/or alternatively, the ontology may comprise an algorithm to determine a meaning of at least one of the one or more search terms with reference to a specific sport, media outlet, user device, weather feature, or personal attribute.

In some embodiments, the at least one additional stored item is related to the user and comprises a personal profile of the user. For example, the personal profile of the user may comprise at least one of a profession, age, gender, location, and language of the user. Additionally and/or alternatively, the personal profile of the user may comprise at least one of demographics, behaviors, and techno-graphics of the user. Techno-graphics refers generally to a market research driven approach for examining and utilizing user profile data.

In some embodiments, the at least one additional stored item is related to the user and comprises a behavioral history of the user. For example, the behavioral history of the user may comprise a search history of the user. The search history of the user may comprise at least one query input by the user subsequent to the user clearing the search history.

Additionally and/or alternatively, the behavioral history of the user may comprise one or more events, with at least one of the one or more events comprising at least one of a search query, a click, and a page view. Each of the one or more events may be assigned a weight. The weight assigned to a search query may be greater than the weight assigned to a click or a page view. The weight assigned to a given event may decrease as an elapsed time since the given event increases.

In another aspect, a method of presenting a set of search results includes the steps of: receiving a query input by a user, the query comprising one or more search terms; generating the set of search results; filtering the generated set of search results; ranking the filtered set of search results; and displaying the ranked set of search results. At least one of the steps of generating, filtering, ranking, and displaying are based on the one or more search terms and are further based on at least one additional stored item related to the user. The additional stored item includes at least one of: a user ontology algorithm, a personal profile of the user, and a search history of the user. For example, the at least one additional stored item may comprise a user ontology algorithm which determines a special meaning of at least one of the one or more search terms with reference to the user.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of presenting a set of search results, comprising the steps of:
receiving a query input by a user, the query comprising one or more search terms;
generating the set of search results;
filtering the generated set of search results;
ranking the filtered set of search results; and
displaying the ranked set of search results;
wherein at least one of the generating, filtering, ranking, and displaying are based on the one or more search terms and are further based on at least one additional stored item, the at least one additional stored item being related to at least one of the user and the query; and
wherein the at least one additional stored item comprises at least one of: an ontology of the one or more search terms, a personal profile of the user, and a behavioral history of the user.

2. The method of claim 1, wherein the at least one additional stored item is related to the query and comprises an ontology of the one or more search terms.

3. The method of claim 2, wherein the ontology comprises a topic specific language ontology.

4. The method of claim 2, wherein the ontology comprises an algorithm to determine a meaning of at least one of the one or more search terms in a specific industry or location.

5. The method of claim 2, wherein the ontology comprises an algorithm to determine a meaning of at least one of the one or more search terms with reference to a specific brand, company, project or organization.

6. The method of claim 2, wherein the ontology comprises an algorithm to determine a meaning of at least one of the one or more search terms with reference to a specific sport, media outlet, user device, weather feature, or personal attribute.

7. The method of claim 1, wherein the at least one additional stored item is related to the user and comprises a personal profile of the user.

8. The method of claim 7, wherein the personal profile of the user comprises at least one of a profession, age, gender, location, and language of the user.

9. The method of claim 7, wherein the personal profile of the user comprises at least one of demographics, behaviors, and techno-graphics of the user.

10. The method of claim 1, wherein the at least one additional stored item is related to the user and comprises a behavioral history of the user.

11. The method of claim 10, wherein the behavioral history of the user comprises a search history of the user.

12. The method of claim 11, wherein the search history of the user comprises at least one query input by the user subsequent to the user clearing the search history.

13. The method of claim 10, wherein the behavioral history of the user comprises one or more events, at least one of the one or more events comprising at least one of a search query, a click, and a page view.

14. The method of claim 13, wherein each of the one or more events is assigned a weight.

15. The method of claim 14, wherein the weight assigned to a search query is greater than the weight assigned to a click or a page view.

16. The method of claim 14, wherein the weight assigned to a given event decreases as an elapsed time since the given event increases.

17. The method of claim 1, wherein at least one of the generating, filtering, ranking, and displaying are based on the one or more search terms, the ontology of the one or more search terms, the personal profile of the user, and the search history of the user.

18. A method of presenting a set of search results, comprising the steps of:
receiving a query input by a user, the query comprising one or more search terms;
generating the set of search results;
filtering the generated set of search results;
ranking the filtered set of search results; and
displaying the ranked set of search results;
wherein at least one of the generating, filtering, ranking, and displaying are based on the one or more search terms and are further based on at least one additional stored item, the at least one additional stored item being related to the user; and
wherein the at least one additional stored item comprises at least one of: a user ontology algorithm, a personal profile of the user, and a behavioral history of the user.

19. The method of claim 18, wherein the at least one additional stored item comprises a user ontology algorithm which determines a special meaning of at least one of the one or more search terms with reference to the user.

20. A system for presenting a set of search results, comprising:
means for receiving a query input by a user, the query comprising one or more search terms;
means for generating the set of search results;
means for filtering the generated set of search results;
means for ranking the filtered set of search results; and
means for displaying the ranked set of search results;
wherein at least one of the generating, filtering, ranking, and displaying are based on the query input and at least one additional stored item, the at least one additional stored item being related to at least one of the user and the query; and
wherein the at least one additional stored item comprises at least one of: an ontology of the one or more search terms, a personal profile of the user, and a behavioral history of the user.
